(19) United States
(12) Patent Application Publication
(10) Pub. No.: US 2010/0194182 A1
(43) Pub. Date: Aug. 5, 2010

(54) DRIVE FOR A TWO-WHEELED VEHICLE

(75) Inventor: Carsten Katz, Buerglen (CH)

Correspondence Address: BIRCH STEWART KOLASCH & BIRCH, PO BOX 747, FALLS CHURCH, VA, 22040-0747, US

(73) Assignee: Katz Biking GmbH, Altdorf UR (CH)

(21) Appl. No.: 12/669,418

(22) PCT Filed: Jul. 19, 2007
(86) PCT No.: PCT/CH2007/000355

§ 371 Date: Mar. 23, 2010

(51) Int. Cl. B60B 27/04; F16H 7/12

(52) U.S. Cl. 301/109; 474/134

(57) ABSTRACT

A wheel hub (8) for a two-wheeled vehicle and a traction element transmission that can be coupled to the wheel hub (8) are described. The wheel hub (8) comprises, inter alia, an axle, a housing, a driver, a transmission, which couples the driver and the housing to one another, an output wheel (13) of a traction element transmission, and a releasable coupling, which couples the output wheel (13) to the driver. The output wheel (13) is attached to the two-wheeled vehicle in such a way that it remains on the two-wheeled vehicle when the coupling between the driver and the output wheel (13) is released.

The traction element transmission for a two-wheeled vehicle, in which the rear wheel is attached rigidly to the frame or is supported in a sprung manner on a swing arm, comprises an input wheel (12), an output wheel (13) and an endless coupling means (14). In this arrangement, the input wheel (12) and the output wheel (13) interact directly with the endless coupling means (14). The traction element transmission furthermore comprises a first compensation mechanism, which acts on a guide wheel (15.1, 15.2) for the coupling means (14), by means of which compensation mechanism the guide wheel (15.1, 15.2) can be moved over a first radial path, and a second compensation mechanism, which acts on a guide wheel (15.1, 15.2) for the coupling means (14), by means of which compensation mechanism the guide wheel (15.1, 15.2) can be moved over a second radial path. Here, the first path is longer than the second path.

The interplay between these two components makes possible a two-wheeled vehicle, the traction element transmission of which is safe and requires little maintenance despite its mobile rear-wheel swing arm, which may be present, and the rear wheel of which can be removed from the two-wheeled vehicle without interfering with the traction element transmission.

### TECHNICAL FIELD

The invention relates to a drive arrangement for a two-wheeled vehicle with a rear wheel with a traction element transmission and a wheel hub. In this arrangement, the traction element transmission comprises an input wheel, an output wheel, a guide wheel and an endless coupling means between the input wheel and the output wheel. The output wheel acts via a coupling on a driver and said driver acts via a transmission on a housing of the wheel hub, which is situated around an axle and is supported in an axle bearing. The invention furthermore relates to a two-wheeled vehicle with such a drive arrangement.

### PRIOR ART

Bicycles are generally fitted with a mechanical drive which transmits the human muscle power of the legs to a drive system via two pedals and via two cranks. This drive system then transmits the power to the rear wheel of the two-wheeled vehicle by way of a transmission ratio, which is generally variable.

A large proportion of the bicycles currently sold has what are referred to as dérailleur gears, in which the drive system comprises a chain, one or more chain wheels at the crank, a plurality of chain wheels at the rear wheel hub, and one or two dérailleurs. In dérailleur gears, the position of the chain is shifted transversely to its direction of running by actuating the dérailleurs. In this way, the chain acts selectively on chain wheels of different sizes and numbers of teeth, thus providing different transmission ratios. Because of the different combinations of chain wheels of different sizes and hence different effective chain lengths, there has to be a flexible chain tensioner which keeps the chain tension at a substantially constant value and is generally integrated into the rear dérailleur.

A similarly large proportion of the bicycles currently sold has what are referred to as hub gears, in which the drive system comprises a chain, one or more chain wheels at the crank, one or more chain wheels at the rear wheel hub, a hub with a built-in transmission, often a rear flexible chain tensioner and, where there is a number of chain wheels at the crank or the rear wheel hub, a front or rear dérailleur. The transmission ratio of the drive is changed by changing the internal transmission ratio in the hub and, where there is a plurality of chain wheels at the crank or the rear wheel hub, by actuating dérailleurs to alter the path of the chain.

In addition to these two solutions, there are bicycles in which the drive comprises a hub gear combined with a drive shaft (e.g. DE 3 120 552 or U.S. Pat. No. 5,852,948). A hub gear can likewise be driven by a belt (especially by a toothed belt) (e.g. DE 3 521 150 A1).

Very recently, moreover, bicycles have been disclosed on which a transmission integrated into the frame is driven directly or indirectly by way of the cranks, and the rear wheel is driven by way of a chain and chain wheels at the output of the transmission and at the rear wheel hub (e.g. WO 01/15963, US 2005062254, EP 0 899 187). Moreover, these bicycles can be fitted with special rear wheel hubs which allow the rear wheel to be removed without having to remove the rear chain wheel from the frame (e.g. DE 10 2004 063 505 A1).

Generally, current drive systems have a number of deficiencies.

The rear dérailleurs are in a very exposed position to the side of the rear wheel, with the result that they may be bent or torn off or their points of attachment to the frame bent or torn off by contact with large stones, by branches caught in the rear wheel or by the two-wheeled vehicle falling over, for example. On bicycles with a hub gear, especially on those bicycles which have a mobile swing arm, there are often chain tensioners similar to dérailleurs, which are similarly susceptible to such external influences.

Since the chain in dérailleur gears is forced to move sideways under high load over chain wheels, the chain is stressed in an unsuitable manner, and may be deformed or break.

The front chain wheels may strike an obstacle, such as a high step, when passing over it, and as a result teeth may snap off or entire chain wheels may be bent.

Moreover, the chain may jump off the chain wheel closest to the center of the wheel and, as a result, may cut deep notches in the rear wheel spokes or even destroy them.

Furthermore, the chain may fall sideways off the chain wheels both at the rear wheel and at the crank and become jammed between the chain wheels and the frame, thereby cutting a deep notch or notches in said frame, something that may have a considerable effect both on static strength and fatigue strength. The anticorrosion layer on the frame is also damaged by the chain striking the chain stay, leading to corrosion and hence weakening of a load-bearing component.

The positioning of the dérailleur relative to the chain wheels is often imprecise due to bent dérailleurs and to soiling, freezing or corrosion of the dérailleur actuation mechanism, and this can lead to anything from unintended gear changes to the chain jumping backward and forward in an uncontrolled manner between two adjacent chain wheels.

If the dérailleur is damaged, the dérailleur actuation mechanism is soiled, frozen or corroded or the load on the chain is high when shifting with the front dérailleur, the spring force in the dérailleur, the strength of the dérailleur actuation mechanism or the strength of the user may not be enough to change between two gears.

The chain may jump completely or partially off the chain wheels and become jammed owing to shocks during riding, actuation of a dérailleur under load, incorrect spacing of chain wheels, a displaced lateral dérailleur limit stop, a bent dérailleur, backpedalling at a sharp chain angle, backpedalling with very dirty dérailleur rollers, or loss of tooth engagement at the front, for example. On the one hand, jamming of the chain leads to an interruption in riding, but it can also damage load-bearing parts, unexpectedly lock up the rear wheel or lead to a sudden loss of resistance on the pedal, which may lead to a fall.

Owing to wear or when chain wheels are contaminated with dirt, snow or ice, the chain may skip individual teeth.

With dérailleur gears, it is not possible to change gear without turning the cranks. In city traffic or after sudden braking maneuvers, however, it is often necessary to change from a riding gear to the starting gear when the bicycle is stationary.

The flexible chain tensioner gives the chain freedom of motion, and shocks and pedaling movements may lead to the formation of overruns in the chain which lock up the drive suddenly and can destroy the chain.

Malfunctions, especially those which require an immediate reaction by the rider, distract the rider of the two-wheeled vehicle from the road traffic or the way, and this can lead to dangerous situations.

In the case of an open design, the drive may be contaminated at any time by mud, sand or dust, and this leads to rapid wear and a reduction in efficiency owing to the fact that the dirt particles are very hard and very small. Moreover, the drive train is exposed to rain, snow or, when riding through streams, to the surrounding water, and as a result lubricant in the drive is washed out within a short time. Moreover, the lubricant is washed out particularly quickly and thoroughly if the bicycle is washed using high-pressure cleaning systems. The washing out of the lubricant increases the friction between the individual components of the drive and thus also wear, and promotes corrosion, and likewise leads to a loss of efficiency. To counteract the increased friction and the increased wear associated therewith, the drive must be oiled or greased regularly and at short intervals. During this process, however, brake linings or brake disks may quickly be contaminated, thereby significantly impairing their operation. Furthermore, the user's hands and clothes very often get dirty when applying oil or grease to the drive.

Lubricant which has been washed out contaminates the environment with oil, and this is problematic particularly on unpaved paths in mountain areas. In addition, the flexibility of the drive allowed by the chain tensioner gives rise to noise owing to the fact that the chain and the dérailleur strike the frame.

A chain running at an angle imposes additional loads on the chain and the gearwheels in a particularly unfavorable manner in the case of certain gearwheel combinations.

Owing to the sensitivity of the drive to damage and environmental influences and because of the great fragility of the systems, drives of this kind require a lot of maintenance.

When a wheel is being removed, as required, for example, in order to change a tire, there is a great risk that the hands will come into contact with the lubricant for the drive and get dirty. The hands also quickly get dirty during other activities, such as transportation, regular maintenance work or the operation of a shackle or cable lock.

Owing to the drive being exposed, clothes, especially trousers and dresses, are soiled by the lubricant for the drive. Moreover, trouser legs, dresses or laces may be trapped between the front chain wheels and the chain and torn during the movement of the pedals.

Removing a wheel is complicated and time-consuming. In the case of certain hub gears, in which the chain runs in a chain case, it is additionally necessary to remove part of the chain case before removing the wheel since the rear chain wheel is connected in a fixed manner to the hub and has to be released manually from the chain wrapped around it to allow removal.

Some of today's drive systems are very expensive, for which reason they represent a high risk of theft. There are no reliable methods of securing high-value hub gears, in particular. Moreover, the drive is particularly susceptible to possible vandalism owing to its exposed position.

For racing and indeed also when changing from summer to winter tires, for example, a second set of wheels is often installed in the frame of the bicycle. However, since the chain wheels of the various rear wheels are generally worn to different extents, the malfunctions described above multiply. At any rate, the wear of the entire drive is accelerated beyond what is usual by the differences in wear on the chain and chain wheels.

In the case of a sprung mobile swing arm on the bicycle, it is desirable that the spring suspension should be influenced as little as possible by the drive and that the drive should be influenced as little as possible by the spring suspension. For this reason, the center of rotation of the mobile swing arm, in particular, must be chosen in consideration of the geometry of the drive.

If the center of rotation of the mobile swing arm is below the load-bearing strand of the chain, a pull on the chain generally leads to an inward deflection of the mobile swing arm. In the case of drives with more than one chain wheel, it is thus generally impossible to position the center of rotation in such a way that the pitch behavior is neutral when starting off in any transmission ratio.

If the chain link situated nearest to the center of rotation of the swing arm is above or below the center of rotation of the swing arm, it undergoes a forward or rearward motion when the mobile swing arm is deflected inwards, and this leads to a forward or rearward rotation of the crank. The same thing happens in reverse during the outward deflection process. This “pedal kickback” leads to a change in chain tension during each deflection process, a change which is troublesome for the rider. Consequently, it is not readily possible to prevent this effect in the case of gearwheels of different sizes such as those which are used in a dérailleur gear.

This effect is not so evident when the center of rotation of the mobile swing arm is relatively close to the bottom bracket. However, the external loads which occur with such positioning of the center of rotation act at an unfavorably acute angle on the mobile swing arm, lowering its efficiency and reducing ride comfort and riding safety.

### SUMMARY OF THE INVENTION

It is the object of the invention to provide a drive arrangement belonging to the technical field indicated at the outset which avoids the abovementioned disadvantages of the prior art.

This object is achieved by the features of claims 1 and 15. According to a first aspect of the invention, a wheel hub for a two-wheeled vehicle comprises an axle, a housing, a driver, a transmission with at least two different ratios, which couples the driver and the housing to one another, an output wheel of a traction element transmission, a releasable coupling, which couples the output wheel to the driver and an axle bearing, the output wheel being attached to the two-wheeled vehicle in such a way that it remains on the two-wheeled vehicle when the coupling between the driver and the output wheel is released. In this arrangement, the output wheel is preferably supported on a rolling contact bearing. For the purpose of fixing the wheel hub on the two-wheeled vehicle, the axle is supported in the axle bearing. A plane which is extended perpendicularly to the axle and extends through the coupling-side end of the axle is aligned substantially parallel to a center plane of the output wheel and to a plane extending through the transmission-side end of the drive-side axle bearing, and extends between these two planes both in the attached condition, i.e. the condition of readiness for riding, and during the release of the coupling. In this case, the term “release of the coupling” is intended to mean the entire process between a first condition and a second condition, in the first condition there being a fastened connection, ready for riding, between the output wheel and the driver and, in the second condition, the output wheel and the driver being completely separated from one another.

According to a second aspect of the invention, a traction element transmission for a two-wheeled vehicle with a rear wheel comprises an input wheel, an output wheel and an endless coupling means between the input wheel and the output wheel. The input wheel and the output wheel interact directly with the endless coupling means. A guide wheel for the coupling means is supported on a structural element of the two-wheeled vehicle, on which guide wheel a first compensation mechanism acts. By means of the compensation mechanism, the guide wheel, starting from a zero position, can be moved over a first radial path. Also supported on a structural element of the two-wheeled vehicle is a guide wheel for the coupling means on which a second compensation mechanism acts. By means of the second compensation mechanism, the guide wheel, starting from a zero position, can be moved over a second path. The first path is longer than the second path. Here, a frame of the two-wheeled vehicle, in particular, or the mobile swing arm if the two-wheeled vehicle is embodied with a mobile swing arm on which the rear wheel is supported, may be regarded as a structural element. The second path is limited in such a way that a length of an envelope changes by not more than 0.5% of a length of the endless coupling means when the guide wheel moves over the second path. Here, the envelope denotes the shortest imaginary closed curve which encloses all the wheels of the traction element transmission in the same way as the endless coupling means. The paths can be aligned in the same direction or in different directions. The zero position corresponds to a position which a guide wheel occupies immediately after the fitting of an endless coupling means and—if the two-wheeled vehicle is embodied with a mobile swing arm on which the rear wheel is supported—in the condition of maximum outward deflection of the mobile swing arm. In this context, the condition of maximum outward deflection of the mobile swing arm is the condition in which the spring force to which the mobile swing arm is subjected is at its minimum. In this arrangement, the guide wheel preferably acts directly on the coupling means. The traction element transmission can have one guide wheel or a plurality of guide wheels, it being possible for a first and/or a second compensation mechanism to act on each of the guide wheels.

When changing a wheel, the wheel hub coupling according to the invention makes it superfluous to remove the output wheel from the traction element transmission and any enclosure of the traction element. It is therefore a very easy and uncomplicated matter to fit and remove the driven wheel in/from the drive without getting dirty. The transmission is accommodated in the hub housing and is thus isolated from external influences. This means that the drive is largely maintenance-free.

The traction element transmission according to the invention provides operationally reliable and low-maintenance guidance for an endless coupling means on two-wheeled vehicles, which may be fitted with a sprung rear-wheel swing arm. By virtue of the design according to the invention, the traction element transmission can be enclosed in an elegant manner, and the coupling means runs reliably over the individual wheels of the traction element transmission.

Since no dérailleur gear is provided for the endless coupling means, it does not have to be moved between different gearwheels, thereby greatly reducing wear and susceptibility to faults of the drive. Without a dérailleur gear, it is furthermore unnecessary for the chain to run over combinations of gearwheels of different sizes. Since, for this reason, the envelope does not have different lengths, the use of a chain tensioner is unnecessary, thereby making it possible to avoid a further source of faults for trouble-free operation. Since the traction element transmission can be embodied in a compact manner, it can also be very well enclosed. As a result, the traction element transmission can be shielded from external influences and can be embodied in such a way that it does not lose any environmentally damaging lubricant either. This means that the traction element transmission requires little maintenance, and its service life is thereby also increased. Finally, the efficiency of the traction element transmission is in this way kept as high as possible.

The axle which bears the loads associated with riding can be inserted from both sides directly into the axle bearing arrangement and does not require any connecting elements to attain its capacity to support bending loads because, both in the fastened condition and during release of the coupling, the plane extending through the coupling-side end of the axle lies between the center plane of the output wheel and the plane extending through the transmission-side end of the drive-side axle bearing.

Both the coupling according to the invention and the traction element transmission according to the invention are suitable for various two-wheeled vehicles in general. These include bicycles and motorcycles, in particular. However, use in vehicles that employ the drive technology otherwise customary for two-wheeled vehicles, such as muscle-powered three- and four-wheeled vehicles for example, is also conceivable.

The coupling preferably has effective surfaces which are aligned parallel to the axle and are spaced apart from the axle. This makes it particularly easy to release the coupling by moving the axle radially. In this arrangement, the effective surfaces can be aligned parallel to one another, although it is likewise possible to use effective surfaces that extend obliquely with respect to one another. The fact that the coupling can be released by moving the axle radially means that the axle or parts of the axle do not have to be moved in an axial direction in order to release the coupling. As a result, a wheel connected to the wheel hub can be released from the axle bearing arrangement by a purely radial movement, that is to say, for example, simply by being pulled out downward.

It is also possible for the coupling to comprise effective surfaces that are aligned or positioned in some other way. However, in comparison the preferred embodiment makes release of the coupling easier and represents a particularly uncomplicated embodiment.

In a particularly preferred embodiment, the wheel hub has a mechanism between the effective surfaces of the coupling which compensates for any coaxial deviations and/or deviations in parallelism between the axle, the driver, the axle bearing and the output wheel. In particular, this mechanism can take the form of a play or an elastic element. The mechanism can correct such geometrical manufacturing tolerances or tolerates them.

An embodiment without such a mechanism must accept loads of unknown magnitude if geometrical manufacturing tolerances occur on one of the elements but is also feasible if strict manufacturing tolerances are maintained.

The coupling of the wheel hub preferably comprises effective surfaces which are arranged symmetrically with respect to the axle in such a way that, during power transmission between the output wheel and the driver, forces acting in a radial direction on the axle cancel each other out. As a result, it is substantially a torque that is transmitted, without any additional bending forces or any other remaining forces that go beyond those associated with torque being exerted. Any forces emanating radially from the output wheel and acting on the driver at an effective surface in the coupling are balanced out by equal and opposite forces acting on the other effective surface or surfaces, leaving a resultant tangential force. These in each case tangential forces essentially transmit a torque. Manufacturing tolerances in the geometry of the effective surfaces or the other elements forming part of the coupling can give rise to a force component which acts on parts of the coupling in addition to the torque. To ensure that the wheel hub is highly reliable and has a long service life, the coupling should furthermore be embodied in such a way that it does not take loads that go beyond those associated with transmission of the driving power.

If effective surfaces are arranged asymmetrically, and this is also conceivable, further, linear forces act on the coupling or other components participating in power transmission in addition to the torque. These forces represent an additional stress on the material and reduce the efficiency of the drive. Instead of or in addition to extended effective surfaces, it is also possible for point engagement surfaces to be provided, and these are preferably distributed symmetrically with respect to the axis of rotation.

The wheel hub preferably comprises a selector clutch for controlling the transmission, the selector clutch comprising a first part, which is supported rotatably on the axle, and the selector clutch comprising a second part, which is supported so as to be rotatable about the axle. Control movements for the hub transmission are introduced into the hub by means of the selector clutch. The control movements preferably emanate from shift mechanisms attached to the frame and have to be transmitted to the hub. The control movements are preferably transmitted by rotary movements about the axle of the hub. For this purpose, it is preferable if the two parts of the selector clutch can be rotated about the same axis. In this arrangement, the first, hub-side part of the selector clutch is supported rotatably on the axle of the hub. The second, frame-side part of the selector clutch is then supported rotatably in such a way that the axle of the hub and the axis of rotation about which the second, frame-side part of the selector clutch can be rotated coincide. The two parts of the selector clutch thus rotate about coaxial axes. In this way it is possible to establish a torsionally rigid connection between the two parts of the selector clutch and to transmit rotary movements between these parts. This preferred embodiment is suitable, in particular, for constructing a selector clutch that lies on the same Bide of the hub as the coupling which connects the driver and the output wheel to one another.

In addition, other embodiments of the selector clutch are also possible. In particular, it is also possible for the selector clutch to lie on the other side of the hub, i.e. where there is no coupling between a driver and an output wheel. In this case, the connection between the frame and the hub is less complicated and, accordingly, the selector clutch can be embodied using known controls for hub gears.

It is preferable if the selector clutch can be released by movements of the transmission which are exclusively radial with respect to the axle. Such an embodiment of the selector clutch makes it possible to release the coupling and the selector clutch in a single operation. It is preferable if the movement of the transmission required to release the selector clutch and the movement of the axle relative to the axle bearing required to release the coupling are the same.

The coupling and the selector clutch are preferably designed in such a way that simply inserting the rear wheel into the frame causes them to couple the respective components to be connected, without the need for other elements, such as levers, screws or the like to be used.

In another embodiment, the selector clutch can be released by movements of the transmission other than radial movements, e.g. axial movements or movements which are a combination of axial and radial components. This applies particularly to a selector clutch which lies on the side of the hub on which there is no coupling.

The wheel hub preferably comprises a locking device for locking the wheel hub. In this preferred embodiment, the hub itself can be locked owing to the provision of an axle securing means with a lock cylinder that prevents unauthorized release of the securing means. This enables the wheel hub to be connected to the frame in a theftproof manner. It is advantageous if the axle securing means is implemented on the drive side by extending a lock cylinder.

As an alternative, it is possible to dispense with such a lock cylinder. Protection against theft by means of a shackle or cable lock is likewise possible, although the preferred embodiment with a lock cylinder on the hub offers greater security. If, for example, the shackle or cable lock is used to lock an entire wheel, this does not provide reliable protection against theft since a thief merely has to cut through all the spokes. The hub can then be removed from the wheel.

In a preferred embodiment, the axle of the wheel hub is embodied in one piece. Since rear wheel hubs are exposed to very high dynamic loads, the axles in particular are exposed to high alternating bending stresses. For safety reasons, therefore, the axle is preferably not composed of several parts and is not interrupted. Moreover, the divided axles known from the prior art cannot readily be implemented with the known wheel hubs having an integrated transmission since, in the case of these wheel hubs, there is within the axle an axially movable or rotatable ratio control mechanism that cannot be split up and since the installation space for a divided axle is too limited owing to shift controls and/or transmission components arranged around the axle.

In contrast, an axle which does not have an internal transmission can also be composed of a number of parts connected to one another, for example, by couplings.

The output wheel of the wheel hub is preferably closed off from the environment. In particular, it is situated in a sealed casing. This preferred embodiment has the advantage that the output wheel and, if appropriate, also an endless traction element are protected from external influences. In particular, these can be rain, snow, dirt, water, which could reach the output wheel when the vehicle is ridden through streams or when it is washed, or impacts due to obstacles. An enclosure ensures that the lubricant for the output wheel is kept in the traction element transmission for longer, thereby minimizing wear and losses in efficiency over the long term. Direct damage due to impacts, such as the breaking off of teeth in the output wheel, can likewise be eliminated by an enclosure. Moreover, the environment is protected from pollution by lubricants, something which is particularly worth striving for when riding off-road.

The output wheel can also be exposed in operation or can have an enclosure which is not sealed, such as a chain case, a semi-enclosed chain case or a chain guard.

The axle bearing of the wheel hub is preferably embodied in such a way that it is suitable for receiving the axle laterally. In particular, the axle bearing has laterally arranged, radially aligned slots. In this arrangement, the slots are situated in both parts of the axle bearing, i.e. on both sides of the center plane of the hub, and are aligned substantially parallel to one another, allowing the axle to be inserted into and removed from the axle bearing radially, thereby making it possible to use a disk brake. Compared with rim brakes, disk brakes have better braking performance and are more reliable. Moreover, this design makes possible the use of commercially available hub gears which, by virtue of their design, cannot be fitted with an axially movable axle that bears bending loads since the control mechanism for the gears is situated within the axle.

In addition, an embodiment in which the axle can be removed from the axle bearing by an axial movement is conceivable. If the axle is designed to be of variable length, e.g. as a telescopic axle, the axle can be moved radially towards the axle bearing arrangement and introduced into the axle bearing arrangement by axial extension. The reverse process can be used to remove the axle from the axle bearing arrangement, with the length of the axle first of all being reduced and the axle then being removed laterally from the axle bearing arrangement. If the axle bearing arrangement is in the form of an axle stub, this is preferably secured in the frame by means of an intermediate sleeve. Where the materials are different, this prevents corrosion on components where fatigue is relevant and prevents scratching of the hole in the frame when the axle stub is pressed in. An alternative method is to manufacture the axle stub integrally with the remainder of the dropout.

The coupling of the wheel hub preferably transmits the rotary movements between the out-put wheel and the driver via two effective surfaces, each interacting in a paired configuration. In this arrangement, a first, driver-side part and a second part of the coupling, said second part being on the output-wheel side, each have two effective surfaces. The coupling of the wheel hub preferably has two parts, the first part being firmly attached to the driver and the second part being firmly attached to the output wheel. A connection between the driver and the output wheel is established through the interaction of these two parts of the coupling. The rotary movements of the output wheel are preferably transmitted to the driver via effective surfaces, there being two effective surfaces on the first part and two effective surfaces on the second part of the coupling. One effective surface on the first part and one effective surface on the second part thus interact with one another in each case.

As an alternative, a different number of effective surfaces can be provided. However, symmetrical distribution of the effective surfaces is preferred. Such distribution leads to uniform force distribution between the individual effective surfaces. In this connection, effective surfaces do not have to be very extensive in terms of their surface area but can also be very limited in surface area. This can be significant for a coupling operation, for example.

In a preferred embodiment, the effective surfaces of the coupling are aligned parallel to one another. In this embodiment, symmetrical distribution of the forces between the individual effective surfaces can be achieved in a particularly uncomplicated manner. It is particularly preferred here if the effective surfaces are at equal distances from the axle.

However, it is also possible to embody the effective surfaces so that they are beveled with respect to one another.

In a further preferred embodiment, the effective surfaces of the coupling are aligned obliquely to one another and parallel to one another in a paired configuration. The alignment of the effective surfaces is chosen in such a way as to make engagement of the coupling easier. For this purpose, the effective surfaces are chamfered in such a way that, when the part of the clutch that is on the output-wheel side is rotated in the direction in which load is principally transmitted, two parallel effective surfaces in each case comes to rest upon one another. In the direction of rotation of the coupling which is not the direction in which load is principally transmitted, the effective surfaces are chamfered relative to one another.

In addition, it is also possible for the effective surfaces to have other geometries.

With respect to the second aspect of the invention, it is advantageous if the first path over which a guide wheel can be moved radially by the first compensation mechanism of the traction element transmission, is longer than the second path over which a guide wheel can be moved radially by the second compensation mechanism of the traction element transmission by at least 10%, preferably by at least 40%, and particularly preferably by at least 80%, the relative lengths in each case relating to the length of the second path. It is advantageous if the first path is a multiple of the second path. Thus, for example, different movements of the coupling means can be compensated for to different extents depending on the alignment and lengths of the paths.

However, it is also possible for the length of the first path to exceed that of the second path by less than 10%. It is also possible for the lengths of the paths to be equal.

The traction element transmission is preferably designed in such a way that the same guide wheel can be moved over the first radial path and over the second radial path by means of the first compensation mechanism and of the second compensation mechanism. In this arrangement, the compensation mechanisms can be of the same type or be embodied differently and can be independent or coupled to one another.

However, it is also possible for the traction element transmission to include more than one guide wheel, for example a first and a second guide wheel. In this arrangement, the guide wheel, starting from a zero position, can be moved radially over a first radial path, and the second guide wheel, starting from a zero position, can be moved radially over a second radial path. The first path is longer than the second path.

In particular, the traction element transmission can be embodied in such a way that a guide wheel can be moved radially in a first direction by a first path and the guide wheel can be moved radially in a second direction, for example a direction counter to the first direction, by a second path, the first path being longer than the second path. In this way, it is possible, for example, to achieve a situation where the guide wheel can follow wear-induced lengthening of the coupling means by means of the first mechanism but, for example, allows temporary shortening of the envelope to only a limited extent.

The rear wheel is preferably supported on a swing arm which can move about an axis of rotation and is subject to a spring force. In this arrangement, the distance between the input wheel and the output wheel depends on the position of the mobile swing arm. Here, the mobile swing arm is rotatable about a center of rotation which does not coincide with the center of rotation of the input wheel. In this way, it is possible to reduce the effects of the tension of the coupling means on the deflection of the mobile swing arm and the effects of the deflection of the mobile swing arm on the tension of the coupling means. This also improves the kinematic response of the mobile swing arm. Here, the distance between the axis of rotation of the mobile swing arm and a load-transmitting strand of the endless coupling means is preferably less than the distance between the axis of rotation of the mobile swing arm and the axis of rotation of the input wheel. Such a design has the advantageous effect that a change in the position of the mobile swing arm has minimal effects on the length of the envelope or the tension of the endless coupling means. When the adjustment path of the guide wheel is only very small, it is not possible to compensate for relatively large changes in the length of the envelope or in the tension of the endless coupling means. In other respects, there is a large degree of freedom in the choice of how the components are arranged, thus allowing a structurally efficient, lightweight and safe design. For two-wheeled vehicles with a transmission integrated into the frame, there is furthermore the advantage that the swing arm can be attached directly to the frame. The attachment of the swing arm to the transmission, as is conventional in the prior art, the transmission for its part being attached to the main frame, has structural disadvantages since the swing arm attachment has to accept very high loads.

However, it is also possible for the rear wheel to be supported directly in a rigid manner on the frame of the two-wheeled vehicle, instead of by a mobile swing arm.

It is furthermore also possible for the distance between the axis of rotation of the mobile swing arm and the load-transmitting strand of the endless coupling means to be greater than the distance between the axes of rotation of the mobile swing arm and of the input wheel.

The guide wheel is preferably attached to the mobile swing arm. This means that the guide wheel moves with the mobile swing arm when the latter is deflected inward. The center of rotation of the swing arm, the input wheel, the output wheel and the guide wheel or guide wheels can be positioned relative to one another in such a way that the length of the envelope can be regarded as constant to a good approximation. Together with the second compensation mechanism, this eliminates the risk that the coupling means will jump off the wheels. This can be achieved particularly by attaching the guide wheel or guide wheels to the mobile swing arm. By virtue of the characteristic that the envelope length is substantially constant, it is possible to dispense with a long-travel chain tensioner, which is required in conventional systems and has the known disadvantages. This in turn makes it possible to concentrate the entire drive train within a small space and thus allows a worthwhile enclosure of the entire drive.

The guide wheel can also be attached to the frame of the two-wheeled vehicle. If the traction element transmission has more than one guide wheel, it is also possible for the guide wheels to be distributed between the frame and the mobile swing arm.

It is advantageous if the radial path of the guide wheel which can be moved by means of the second compensation mechanism is limited by fixed stops to less than 1%, preferably less than 0.1%, of the length of the endless coupling means during the operation of the traction element transmission. Here, “operation of the traction element transmission” means power transmission between the input wheel and the output wheel, it being possible for any mobile swing arm that is present to perform deflection movements. Such restriction of the path by which the guide wheel can move also limits the extent of the change in length of the envelope or of the change in the tension of the endless coupling means that makes the traction element transmission feasible. An uncontrolled change in the length of the envelope or change in the tension of the coupling means is thus prevented, hence preventing the coupling means from jumping off the input wheel, output wheel or guide wheel.

To ensure that dimensional deviations, such as manufacturing tolerances, lack of concentricity in the wheels or backlash in bearings, do not lead to a change in the pretension of the coupling means or to overstretching of the latter, the guide wheel or guide wheels is/are supported elastically to allow movement along a limited path. If a coupling means with a division is used, a slightly elastic support arrangement is furthermore necessary to compensate for the polygon effect since this is not negligible when using the wheel diameters that are customary in the construction of two-wheeled vehicles. Limiting the scope for movement of the guide wheel or guide wheels ensures that the traction element cannot jump off or form loops despite the elastic support of a wheel. Moreover, elastic support makes it possible to accommodate slight changes in the length of the envelope caused by movements of the mobile swing arm which may be present.

However, even relatively large tolerances as regards the scope for movement of the guide wheel are conceivable here.

The output wheel preferably remains on the two-wheeled vehicle when the rear wheel is removed, as is allowed, for example, by the first aspect of the invention. This ensures that the traction element transmission remains as a unit, even when the rear wheel is removed. This makes it possible to greatly restrict the scope for movement of individual components of the traction element transmission, especially the guide wheel. It is not necessary to release the output wheel from the endless coupling means and reinsert it into the endless coupling means after subsequent fitting. This is efficient and uncomplicated and reduces the risk of getting dirty when removing a wheel. Efficient enclosure of the traction element transmission is thus also possible since the enclosure does not have to be opened, even when removing a wheel.

As an alternative, it is also possible for the traction element transmission to be embodied in such a way that the output wheel is removed from the two-wheeled vehicle when the rear wheel is removed, especially when the output wheel is firmly connected to the rear wheel.

It is advantageous if the first compensation mechanism and/or the second compensation mechanism comprises a preloaded elastic element for the purpose of supporting the corresponding guide wheel. A guide wheel supported on an elastic and preloaded element makes it possible to compensate for changes in the envelope length or tension of the endless coupling means caused, for example, by a change in the position of a mobile swing arm which may be present. By means of the preloaded support of a guide wheel, it is possible to ensure that the coupling means is always under an adjustable tension. By virtue of the preload, the adjustable tension of the coupling means is kept largely constant even over a wide range of positions of the elastic support of a guide wheel. In this way, the coupling means is prevented from jumping off the input wheel, the output wheel or a guide wheel. In this arrangement, both the first and the second compensation mechanism can act on the same guide wheel, or the two compensation mechanisms act on a plurality of guide wheels, the first compensation mechanism acting on a first guide wheel or on a plurality of first guide wheels, and the second compensation mechanism acting on a second guide wheel or a plurality of second guide wheels.

To ensure that power losses are not unnecessarily severe, despite continuous compression and relief of the elastic element of the guide wheel or guide wheels during the operation of the two-wheeled vehicle, and thus ensure that the power required to operate the drive is as uniform as possible, it is advantageous if the elastic element is preloaded over a multiple of its operating travel. This ensures that the travel-dependent change in the tension of the coupling means is minimized.

As an alternative, the first compensation mechanism and/or the second compensation mechanism can comprise a non-preloaded elastic element to support a guide wheel, which compensates for any changes in the length or tension of the coupling means, e.g. when the mobile swing arm that may be present undergoes inward deflection.

The elastic element is preferably formed by an at least two-part axle, it being possible for a radially acting, preloaded spring element to be accommodated in a core axle. In this arrangement, the spring element acts against a sleeve which forms a jacket around the core axle and is dimensioned in such a way that the sleeve can move on the core axle. It is advantageous if the movement of the sleeve on the core axle is limited to one spatial direction. Given fixed support for the core axle, the sleeve can move elastically relative to the fixed support by virtue of the spring element. The guide wheel is then supported on the sleeve and connected elastically to the core axle via the spring mechanism. Restricting the movement of the sleeve on the core axle to one spatial direction permits a defined directional deflection of the guide wheel and can prevent unwanted movements of the guide wheel.

In addition, it is also possible for the guide wheel to be supported on some other kind of elastic element.

Support on a lever which is supported in an elastically rotatable manner or on a core axle situated in an elastic medium, such as rubber, are further possible implementations of an elastic support arrangement for a guide wheel.

It is preferable if the first compensation mechanism of the traction element transmission compensates for lengthening of the endless coupling means itself. Such lengthening of the endless coupling means arises through wear of the coupling means during operation, and this occurs even with perfectly enclosed coupling means. Wear on other components used in the traction element transmission can also lead to a shortening of the envelope and has the same effect as lengthening of the coupling means. Compensating the lengthening of the coupling means therefore reduces the outlay on maintenance to the traction element transmission. Wear is compensated for by maintaining the tension of the endless coupling means. This can be achieved by means of a further spring element for the guide wheel, for example a ratchet mechanism in addition to the elastic support arrangement for the guide wheel with tightly restricted hard stops, which spring element is preloaded and transmits its load to the coupling means. When a limiting value for the lengthening of the coupling means is exceeded, the ratchet mechanism tightens by one notch and thus maintains the tension of the coupling means. The envelope may likewise change due to a change in the position of a mobile swing arm which may be present, for which reason the ratchet mechanism is designed in such away that retensioning does not result merely from elastic lengthening of the chain under high load or due to a change in the position of the mobile swing arm.

In addition, wear on the coupling means can also be implemented manually, by retensioning the coupling means for example.

It is advantageous if the first compensation mechanism of the traction element transmission comprises a lever, on which a guide wheel is supported, a pivot, a torsion spring, and a leaf spring. The lever is supported rotatably on the pivot and is subjected to a torsional load in the direction of a first sense of rotation by the torsion spring. In this arrangement, the lever is provided with teeth which are arranged sawtooth-fashion in a grid shape and interact with the leaf spring. It is also possible for some other kind of bending spring or a detent pawl to be provided instead of a leaf spring.

It is preferable here if the teeth are embodied sawtooth-fashion in such a way that, in interaction with the leaf spring, the lever can be rotated through a first angular range, in a first sense of rotation, about the pivot in order to move the guide wheel along the first radial path. During rotation of the lever in the first sense of rotation, the leaf spring slides along a respective flat flank of a sawtooth-like tooth, from one tooth to the next. The lever can be rotated through a second angular range, in a second sense of rotation, which is opposite to the first sense of rotation, about the pivot in order to move the guide wheel along the second radial path. Here, the first angular range is greater than the second angular range. During rotation of the lever in the second sense of rotation, the leaf spring strikes against a steep flank of a sawtooth-like tooth after rotating through at most the second angular range, and thus prevents further rotation of the lever in the second sense of rotation. Rotation of the lever in the first sense of rotation can take place over a large angular range, which means that the leaf spring slides over (possibly) a plurality of teeth. The lever can be rotated in the second sense of rotation by only a small angular range, which corresponds to the leaf spring sliding along a flat flank of one tooth.

It is advantageous if the first angular range is larger by at least 10%, preferably by at least 40%, and particularly preferably by at least 80%, in each case in relation to the second angular range, than the second angular range.

In this arrangement, the teeth on the lever of the compensation mechanism each preferably have recesses for the partial accommodation of the leaf spring. The teeth interact with the leaf spring in such a way that the respective depth of the recesses limits the respective second angular range. During rotation of the lever in the second sense of rotation, the leaf spring can be partially accommodated by the recess. It is thus still possible for the lever to be rotated in the second sense of rotation immediately after the leaf spring has slid from a first tooth to a second tooth owing to a rotation of the lever in the first sense of rotation.

In addition, the compensation mechanism can also be embodied in some other way. Thus, it is also possible for the teeth on the leaf spring to be embodied symmetrically. The teeth can also be shaped in such a way that a rotation of the lever is possible in only one sense of rotation or that the lever can be rotated by the same angular range in a first sense of rotation as in a second sense of rotation. It is also possible for the first angular range to be significantly greater than 80% or less than 10% larger than the second angular range.

It is preferable if the traction element transmission comprises an indicator element which indicates a relative change in the length of the coupling means. An indication of this kind can also be used to determine the wear condition of the coupling means if the length of the coupling means increases with increasing wear. An indication of this kind can be achieved, for example, by means of a spring element which measures the tension of the coupling means and assumes a certain length or a certain position in space as a function of the measured tension. A marking applied to a spring element of this kind is a suitable means of determining the wear condition of the coupling means. For example, an inspection window can be fitted in the enclosure of the traction element transmission in the region of the marking, allowing the marking to be seen from outside. The tension of the coupling means can be determined, for example, by means of a guide wheel pressed against the coupling means, the position of the guide wheel being dependent on the tension of the coupling means.

However, it is also possible for the traction element transmission to be embodied without an indication element of this kind.

It is advantageous if the endless coupling means can be pretensioned in a stepless manner to a defined value by means of a calibrated tool, e.g. a torque wrench. This has the advantage, on the one hand, that the coupling means can be adjusted to the optimum tension for the operation of the traction element transmission and, on the other hand, that the wear condition of the coupling means can also be determined. Here the wear condition of the coupling means can be determined by means of its tension or by means of a force required by a compensation mechanism to reestablish the preset pretension.

At the same time, the wear-compensating mechanism offers a way of applying a clearly defined pretension to the coupling means, e.g. by preloading the torsion spring with a torque wrench and transmitting this torque to the coupling means by means of the lever.

However, it is likewise possible to tension the coupling means without setting a defined tension.

It is advantageous if the load-bearing strand of the endless coupling means runs directly from the input wheel to the output wheel. Avoiding direction changes between these wheels in that section of the coupling means which transmits the driving load keeps the efficiency of the traction element transmission at the highest possible level.

In addition, it is also possible for direction changes to be provided between the input wheel and the output wheel in order, for example, to take the coupling means along a different path than that of the direct connection between the input wheel and the output wheel. Direction changes on the load-free side of the coupling means cause hardly any efficiency losses.

It is preferable if the traction element transmission and, in particular, the endless coupling means are separated from the environment by an enclosure. Enclosure of the traction element transmission with respect to the environment ensures that environmental influences can no longer act unhindered on the traction element transmission. For example, the risk of pollution to the environment from lubricant washed out of the traction element transmission is substantially eliminated. Accelerated wear due to the effects of weather, e.g. the washing out of lubricant from the traction element transmission, are also significantly retarded by an enclosure. The enclosure is generally of multi-part construction and, for example, comprises an enclosure for the input wheel, an enclosure for the coupling means and an enclosure for the output wheel. Relative movements between individual enclosures can be absorbed by elastic elements without losing the sealing effect of the enclosure. Specially provided, non-load-bearing casings or, alternatively, already existing load-bearing elements of the two-wheeled vehicle, such as a chain stay or a dropout, can be provided for the purpose of enclosure.

In order to minimize losses of efficiency due to rubbing seals between rotating parts of the traction element transmission and parts of the enclosure and in order to achieve a reliable sealing action there, it is advantageous to make the seals as small as possible in diameter. If the axis of rotation of the input wheel is identical with the axis of rotation of the cranks, this can be achieved by spatially shifting the crank spider relative to the crank towards the center of the two-wheeled vehicle, allowing a cover to be inserted between the crank and the crank spider, by means of which sealing with respect to the crank spider is then accomplished. In this arrangement, the crank spider forms the holder for the input wheel.

In addition, it is also possible for the traction element transmission to be unenclosed or partially enclosed, e.g. by a chain case.

The input wheel is preferably supported in such a way by means of an eccentric that the position of the input wheel relative to the other components included in the traction element transmission can be changed by rotation of the eccentric. This enables the endless coupling means to be fitted without tension and then roughly pretensioned by increasing the distance between the input wheel and the output wheel without changing the position of a guide wheel in the process. This takes place independently of the compensation mechanism.

As an alternative, it is also possible for the input wheel to be supported in a bearing which is not eccentric in construction. It is also possible to tension the coupling means using a further guide wheel, for example, or to make the dropouts movable relative to the remaining parts of a mobile swing arm which may be present or relative to the frame. In addition—in one embodiment of the two-wheeled vehicle, in which the rear wheel is supported on a mobile swing arm—it is also possible for an adjustable center of rotation of the swing arm to be provided for the purpose of tension-free fitting of the coupling means.

The endless coupling means preferably runs at least partially within the swing arm which may be present, where it is well protected against external influences without the need for further enclosures.

In addition, it is also possible for the endless coupling means to run in a separate enclosure or to run free, i.e. unenclosed. The enclosure could run directly along the swing arm or along parts of the frame or be arranged independently of the swing arm or these parts of the frame.

Since neither a chain tensioner nor a dérailleur is required, the two-wheeled vehicle -can be placed directly on its two axle bearing arrangements after removal of a wheel. Since the two axle bearing arrangements are approximately equal in length, the two-wheeled vehicle remains stable in these circumstances, without falling over. This is advantageous, for example, when changing a tire or during transportation.

On a two-wheeled vehicle, it is fundamentally possible for the first aspect of the invention, namely the rear wheel hub according to the invention, and the second aspect of the invention, namely the traction element transmission, to be embodied in combination or individually.

Further advantageous embodiments and combinations of features of the invention will emerge from the following detailed description and from the patent claims as a whole.

### BRIEF DESCRIPTION OF THE DRAWINGS

In the drawings used to explain the illustrative embodiments:

FIG. 1 shows a two-wheeled vehicle in a side view;

FIG. 2 shows an enclosed traction element transmission in a first side view;

FIG. 3 shows a traction element transmission without enclosure in a second side view;

FIG. 4 shows an elastically supported guide roller;

FIG. 5 shows an output wheel with a guide roller and a wear-compensating mechanism;

FIG. 6 shows an indicator belonging to the wear-compensating mechanism;

FIG. 7 shows a two-wheeled vehicle with a frame-mounted transmission;

FIG. 8 shows a traction element transmission with a frame-mounted transmission;

FIG. 9 shows a wheel hub;

FIG. 10 shows an axle bearing with a coupling and enclosure;

FIG. 11 shows an axle bearing with a coupling but without an enclosure;

FIG. 12 shows a wheel hub with a coupling and an axle;

FIG. 13 shows an exploded view of the coupling;

FIG. 14 shows a retention mechanism;

FIG. 15 shows an external view of the retention mechanism;

FIG. 16 shows a section through a wheel hub with a coupling and an antitheft device.

In all the figures, identical parts are provided with the same references.

### EMBODIMENTS OF THE INVENTION

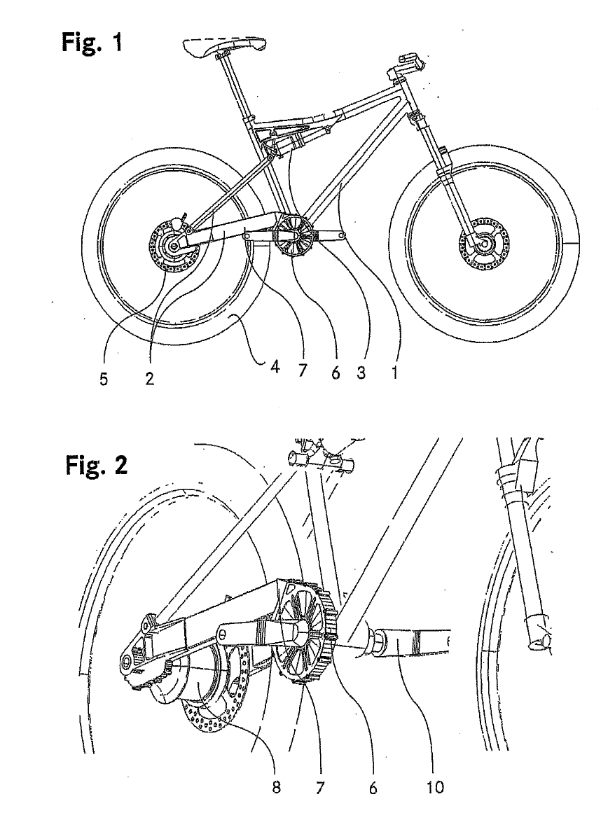

FIG. 1 shows a two-wheeled vehicle according to the invention with a mobile swing arm 2, which is supported movably on the main frame 1 of the two-wheeled vehicle, the position of which is controlled by a spring-damper element 3 and to which the rear wheel 4 is attached. The drive of the two-wheeled vehicle is formed by a traction element transmission, which comprises an input wheel in an enclosure 6, an endless coupling means in an enclosure 7, an output wheel and guide wheels. The two-wheeled vehicle is fitted with a disk brake 5 on the rear wheel 4.

FIG. 2 shows the drive of the two-wheeled vehicle in the assembled condition. A front chain wheel surrounded by an enclosure 6 is attached to a crank 10 having pedals. From the front chain wheel, the endless coupling means in the form of a drive chain leads in the direction of the rear wheel hub 8. The drive chain likewise runs in an enclosure 7 and drives an output wheel, which is likewise enclosed and is connected to the rear wheel hub 8 in such a way that the latter moves with the rotation of the output wheel.

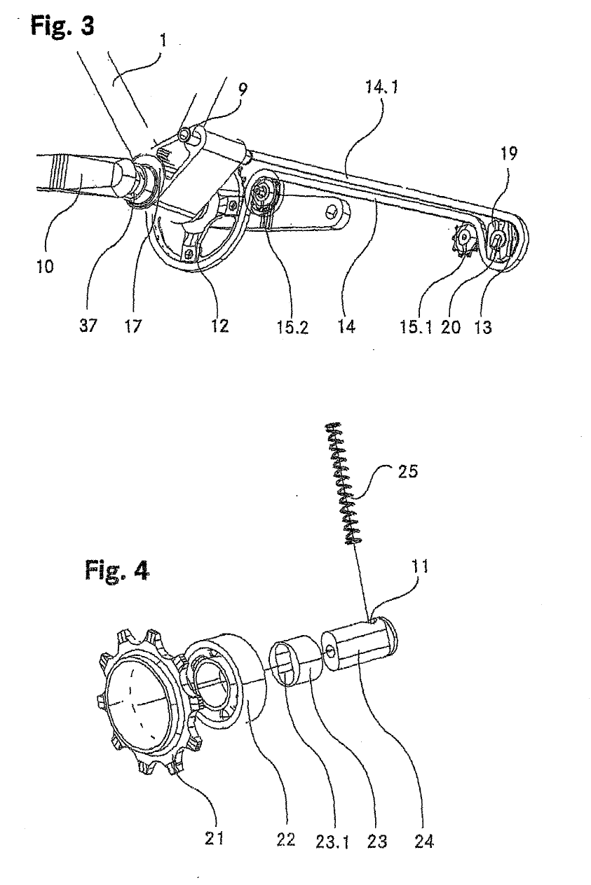

FIG. 3 shows an embodiment of the traction element transmission. In this figure, the traction element transmission comprising the input wheel 12, the output wheel 13, the two guide rollers 15.1, 15.2 and the chain 14 are depicted. The guide wheels 15.1, 15.2 serve, on the one hand, to guide the chain 14 and, on the other hand, for the adjustment of the length of the chain 14, which can change easily as a function of the swing position of the mobile swing arm and of wear. For reasons connected with optimizing efficiency, the load-bearing strand 14.1 of the chain 14 runs directly between the input wheel 12 and the output wheel 13. For this reason, the guide rollers 15.1, 15.2 act on the returning, lower part of the chain 14. FIG. 3 furthermore shows the coupling part 19 on the output wheel 13, the coupling being used to couple the wheel hub to the traction element 14. The coupling part 19 also has an axle bearing arrangement 20 for the rear wheel hub. The input wheel 12 rotates about the center of rotation 37 of the crank 10. Here, this axle 37 is supported in an eccentric 17 in the frame 1 of the two-wheeled vehicle. By adjusting the eccentric 17, it is possible to move the axle 37 of the crank 10 and the axle 37, identical with the latter, of the input wheel 12 perpendicularly to their orientation. This makes it possible to tension the chain 14 by changing the distance between the input wheel 12 and the output wheel 13. This tensioning is advantageous especially in connection with maintenance work, such as changing the chain 14 or one of the gearwheels. The pivot 9 about which the swing arm swings is likewise indicated and is situated next to the axis of rotation 37 of the input wheel 12. The pivot 9 of the swing arm is in the immediate vicinity of the load-bearing strand 14.1 of the chain.

FIG. 4 shows, in an exploded view, one possible configuration of an elastically supported guide wheel provided with fixed stops. The guide wheel comprises an axle 24, which is here attached to the two-wheeled vehicle by means of an axial thread and on which the rotating part of the guide wheel, in this case a chain wheel 21, is supported. The axle 24 has a lateral bore 11, which extends in a radial direction and into which an elastic element, in this case a spring 25, can be inserted. A sleeve 23 is pushed over the axle 24, the interior 23.1 of said sleeve being larger than the axle 24. As a result, the axle 24 has play within the sleeve 23 and the compressed spring 25 acts toward the interior 23.1 of the sleeve. The axle 24 is thereby pressed against the stop of the interior 23.1 of the sleeve 23, said stop lying opposite the bore 11 with the spring 25 contained therein. A bearing 22—preferably a rolling contact bearing—and a chain wheel 21 matching the traction element is mounted on the sleeve 23. In this way, the sleeve 23 performs the function of a stop for a possible radial movement of the bearing 22 and of the chain wheel 21 on the axle 24. The ratio between the size and shape of the interior 23.1 of the sleeve 23 and the external size and shape of the axle 24 determines by what distance and in what direction the sleeve 23 and hence the chain wheel 21 can move relative to the axle 24, which is installed in a fixed manner on the two-wheeled vehicle. If the sleeve 23 has an elongate interior 23.1, as in this figure, the movement of the sleeve 23 on the axle can be restricted to a linear motion in the direction of the longer orientation.

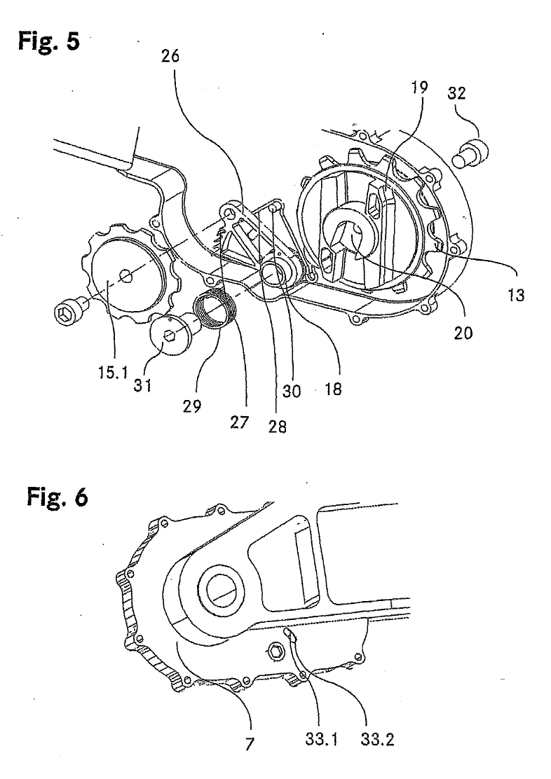

FIG. 5 shows a wear-compensating and indicating mechanism according to the invention. The covering of the drive and the traction element are not shown. In the embodiment shown here, the mechanism comprises an elongate lever 26, which is supported on a pivot 18 and on which, in turn, the rear guide wheel 15.1 is supported. The rear guide wheel 15.1 is mounted on the opposite part of the lever 26 from the pivot 18. Through rotation about its pivot 18, the lever 26 thus moves the guide wheel 15.1. The chain can thereby be tensioned in an effective manner. For this purpose, the lever 26 is subject to the action of a torsion spring 29 which interacts with a nut 31 and a screw 32 fastened in the pivot 18 of the lever 26. In this arrangement, the torsion spring 29 is connected in a torsionally rigid manner at one of its ends to the lever 26 and at its other end to the nut 31, the nut being supported in the pivot 18 of the lever 26 and the torsion spring 29 being stressed by rotation of the nut 31 relative to the lever 26. The nut 31 interacts with the screw 32 in such a way that a screw-nut connection is formed, clamping the corresponding wall of the enclosure and/or the swing arm and thus participating in a torsionally rigid clamped connection with the housing of the enclosure and/or the swing arm. The torsion spring 29 can preferably be subjected to torsion via the nut 31 by means of a torque wrench and preloads the lever 26 relative to the nut 31 and hence indirectly relative to the housing of the enclosure and/or the swing arm. Here, the preloading of the lever 26 counteracts the force acting on the guide wheel 15.1 due to the tension of the chain. As soon as the tension of the chain slackens and the force exerted on the lever 26 and the guide wheel 15.1 by the torsion spring 29 is greater than the force of the chain, the lever 26 is adjusted accordingly and in this way retensions the chain. To prevent a larger force of the chain pushing the lever 26 back again, a retention device comprising sawtooth-like teeth 27 is furthermore provided. In the region of the lever 26 in which there is the most travel during a rotation about the pivot 18, the retention device has asymmetrically formed sawteeth 27 which perform the function of barbs. Interacting therewith is a spring 28, which is attached to the housing of the enclosure and/or to the swing arm, and the free end of which engages in the individual teeth 27 and blocks the lever 26 in the direction counter to the chain tension. In the direction of action of the torsion spring 29, by contrast, movement of the lever 26 is readily possible. This ensures that, once the lever 26 has been retightened, it does not give way again to large subsequently occurring loads on the chain and large associated chain forces on the guide wheel 15.1. Depending on the stress in the torsion spring 29, the lever 26 can rotate by a few degrees of angle and retension the chain by the amount of travel resulting therefrom.

In this arrangement, the retention device ensures that the chain cannot come off owing to uncontrolled oscillations of the system due to the effect of accelerations of or loads on the input wheel, the output wheel 13 or a guide wheel 15.1, despite the fact that a considerable retensioning travel is possible The scope for movement of the lever 26 is preferably limited by a fixed stop 30. On the one hand, this stop 30 serves to ensure correct setting of a wear indicator when the system is installed and, on the other hand, prevents the guide wheel 15.1 from adopting unwanted positions if the retention device fails.

FIG. 6 shows the enclosed rear side of the mechanism depicted in FIG. 5. A marking 33.1 is preferably applied to the lever in such a way that it can be seen from the outside through an inspection window 33.2. In this way, the position of the lever can be determined from outside and hence the degree of wear of the traction element transmission can be read off without having to open part of the enclosure 7.

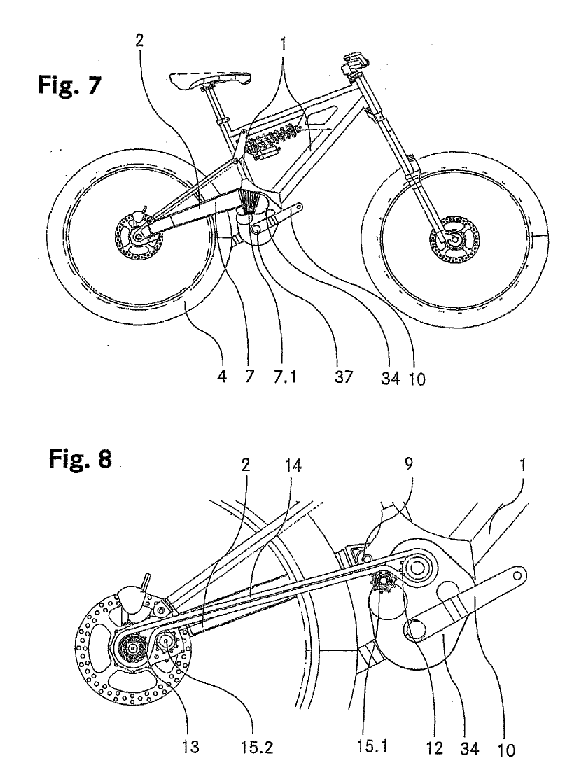

FIG. 7 shows one possible configuration of a two-wheeled vehicle fitted with a transmission 34 integrated into the frame 1. The operating principle is similar to that of the two-wheeled vehicle illustrated in FIG. 1, although a significant difference between the two-wheeled vehicle illustrated in FIG. 1 and the two-wheeled vehicle illustrated in FIG. 7 is that the axle of the input wheel does not coincide with the axle 37 of the crank 10. The two-wheeled vehicle comprises a main frame 1 with a swing arm 2 which is supported movably and suspended thereon. The transmission 34 is driven by the crank 10 and transmits its rotation to the chain. In this embodiment, the enclosure 7 of the chain has a bellows 7.1 which adapts to relative movements between the swing arm 2 and the frame 1, ensuring that the enclosure remains sealed even during such movements.

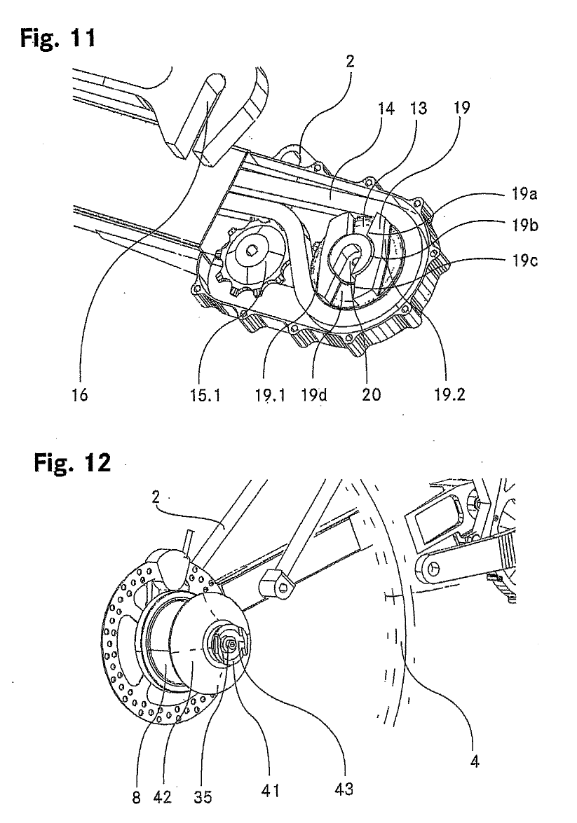

FIG. 8 shows the drive on the two-wheeled vehicle from FIG. 7 fitted with a frame--mounted transmission 34. Pedals drive the crank 10, which is connected to the input wheel 12 of the traction element transmission via the transmission 34 integrated into the main frame 1 of the two-wheeled vehicle. In the frame-mounted transmission 34, an initial conversion of the force can take place. The input wheel 12 transmits its movement via the chain 14 to the the output wheel 13. In this arrangement, the chain 14 is guided within the mobile swing arm 2 by the two guide rollers 15.1, 15.2, which act on the lower part of the chain 14. That part of the swing arm 2 which encloses the chain 14 is not shown in FIG. 11 for the sake of clarity. The swing arm 2 can move about its pivot 9, the pivot 9 being positioned in the vicinity of the chain 14.

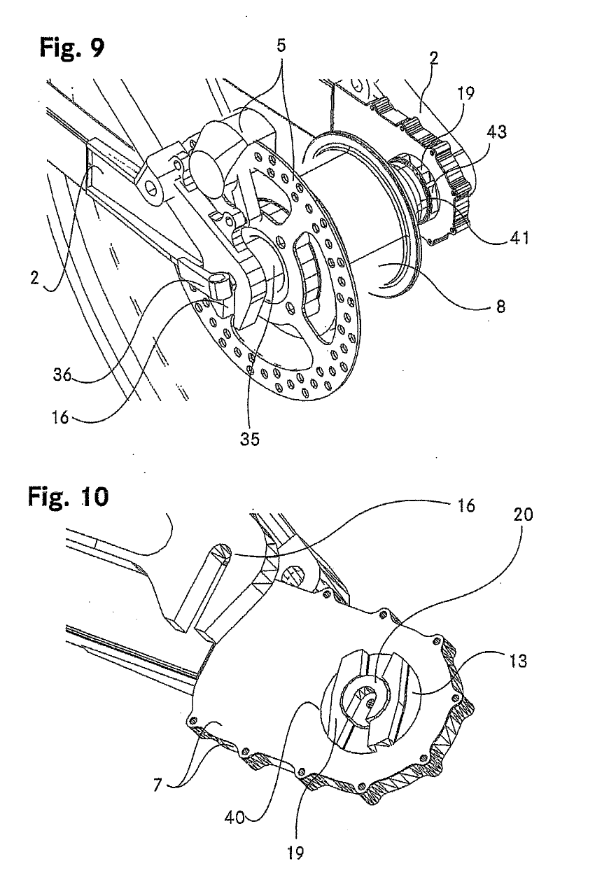

FIG. 9 shows the rear wheel hub 8 mounted in the two-wheeled vehicle. On a first side, the hub 8 is fixed directly in the axle bearing 16 of the swing arm 2. The axle bearing 16 can receive the axle 35 of the hub 8 on the first side of the hub 8 via a slot in the mobile swing arm 2 without the need for the axle 35 or the hub 8 to perform an axially oriented movement. The axle bearing arrangement 20 on the second side of the hub 8 likewise allows this movement, as will be evident from FIG. 10, for example. The axle bearing arrangement 20 in said figure is integrated into the coupling part 19, which is situated on the swing arm 2. The coupling part 19 of the swing arm 2 interacts with the hub-side coupling part 43 and thus couples the output wheel 13 of the traction element transmission to the driver 41 of the hub 8. The axle 35 is secured against falling out in its axle bearing arrangement 16 by a quick-release pin 36. In general, the hub 8 has a receptacle for a brake 5, e.g. a disk brake.

FIG. 10 shows the axle bearing arrangements 16, 20 for an axle of a rear wheel hub. The enclosure 7 of the traction element transmission is shown on the coupling-side part of the swing arm. Projecting inward from said enclosure is a rotatable part of the coupling 19, which is connected directly to the output wheel 13 of the traction element transmission. This part 19 of the coupling rotates about the corresponding axle bearing arrangement 20. Once an axle securing means has been released, the wheel hub can slide downward out of the coupling part 19, the axle bearing arrangement 20 and any disk brake caliper 5.2 which may be present. When the wheel is removed, the output wheel 13 remains in the swing arm 2. A seal 40 can be fitted between the output wheel 13 and the enclosure 7 to prevent lubricant from escaping and dirt and water from entering.

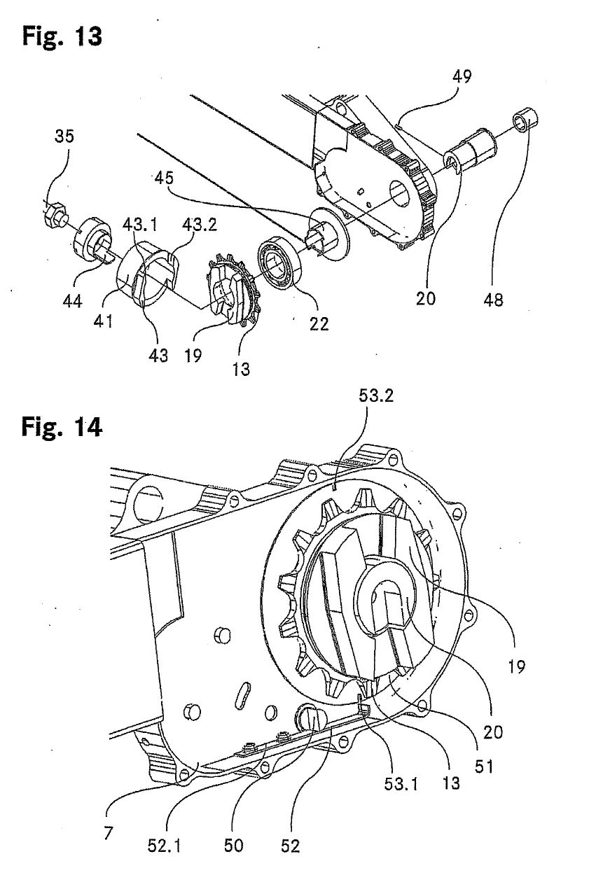

FIG. 11 shows the configuration of the swing arm-side part of the coupling 19 and of the axle bearing arrangement 20 without an enclosure, this configuration being the one illustrated in FIG. 10. The drive-side axle bearing arrangement 20 comprises an axle stub, which is attached immovably to the swing arm 2, by being press-fitted or shrink-fitted into a corresponding bore in the swing arm 2, for example. At its inner, hub-side end, the axle bearing arrangement 20 has a radial slot, which is preferably aligned so as to be substantially vertical, the alignment of which corresponds substantially with that of the slot of the axle bearing arrangement 16 on the opposite side of the swing arm. The insertion and removal of an axle can then take place through a radial movement relative to the geometrical axis formed by the two axle bearing arrangements 16, 20. To enable the output wheel 13 also to be simultaneously coupled to the driver of the hub during this movement, the coupling part 19 has two elongate, beam-like dogs 19.1, 19.2, aligned substantially parallel, on each side of the axle bearing arrangement 20. The dogs 19.1 and 19.2 are made rotationally symmetrical with respect to one another. They form substantially parallel beams, the inner flanks of which can be divided into an inner region 19b and two outer regions 19a and 19c, the inner region 19b partially surrounding the axle bearing arrangement 20 and having a recess which is made round to correspond to the outer contour of the axle bearing arrangement 20. The outer regions 19a and 19c of the inner flanks of the dogs 19.1 and 19.2 are made mirror-symmetrical with respect to a plane extending through the center of the axle bearing arrangement 20 and substantially perpendicular to the alignment of the dogs 19.1 and 19.2. The outer regions 19a and 19c of the inner flanks of opposite dogs 19.1 and 19.2 extend obliquely toward one another in such a way that, given appropriate alignment of the coupling part 19, they guide a part of an axle 35 inserted from outside into an interspace 19d between the dogs 19.1 and 19.2, toward the slot of the axle bearing arrangement 20, while at the same time centering it. The outer flanks of the dogs form effective surfaces via which power is transmitted from one part 19 of the coupling to the other part 43 of the coupling. Furthermore, the outer flanks of the dogs 19.1 and 19.2 converge in a wedge shape in the direction of the rim of the output wheel 13, relative to the respectively opposite flank. At the same time, the dogs 19.1, 19.2 are as far as possible aligned parallel to the slot in the axle bearing arrangement 20. The two dogs 19.1, 19.2 of the driven part of the coupling 19 preferably engage on the two dogs 43.1, 43.2 of the hub-side part of the coupling 43 (see FIG. 13).

If a rotary motion is imparted to the output wheel 13 by the chain 14, the torque and the rotational speed are transmitted to the driver 41 from the output wheel 13 via the dogs 19.1, 19.2, 43.1, 43.2 by virtue of the positive engagement between the two coupling parts 19, 43, by way of a force couple formed by surface pressure. To avoid constraints due to alignment and position errors, a play or an elastic element is incorporated between the two coupling parts 19, 43. In this arrangement, the contact surface via which the driving power is transmitted is produced from a material which is as hard as possible in order to minimize wear. As an alternative, the coupling can be provided with replaceable effective surfaces on the dogs 19.1, 19.2, 43.1, 43.2. By virtue of the transmission of the driving torque as a pure force couple, there are no additional loads on the bearings of the driver 41. Further functional surfaces can furthermore be formed on the dogs 19.1, 19.2, 43.1, 43.2, e.g. chamfers, which simplify insertion of the axle through self-centering of the coupling, and functional surfaces for disassembly of the coupling, e.g. for the case where a driver 41 with an integrated coupling is connected by a thread to the transmission of the hub or to the hub housing.

In FIG. 12, the rear wheel 4 of the two-wheeled vehicle with the rear wheel hub 8 is shown in the installed condition. Part of the swing arm 2, the traction element, the guide wheels, the axle stub, the output wheel and the bearings thereof are not shown here. The hub 8 comprises the following three elements, inter alia: in the center, the hub has an axle 35, which accepts the static forces acting on the rear wheel 4 and carries the rear wheel 4. The driver 41 is supported rotatably on the axle 35. The hub-side part of the coupling 43 is mounted directly on the driver 41. Situated on the driver 41 there is, finally, the housing 42 of the wheel hub, which housing is driven by the driver 41 via a transmission situated within the housing 42. The rim and the tire are then attached to the housing 42, for its part, via spokes for example. Depending on the construction of the hub 8, the axle 35 may be tubular and attached nonpositively to the swing arm 2 by means of a tie or a quick-release device 36. It is furthermore also possible for it to have a thread on its end to receive locknuts. It is also possible for the axle 35 to be shaped in some other way to enable it to be fastened in the axle bearing arrangement 16, 20, for example as a smooth cylindrical outer surface which is fastened in the axle bearing arrangement 16, 20 of the two-wheeled vehicle by means of a clamp.

FIG. 13 shows an exploded view of the coupling between the output wheel 13 of the traction element transmission and the driver 41 of the wheel hub, and elements situated directly at the coupling. Gear selection is controlled from the same side as the drive. This construction necessitates the provision of a selector clutch for gear control in addition to the coupling explained above. Between the axle bearing arrangement 20 and the coupling there is a sleeve 45 in the form of a cylindrical jacket with an aperture matched in size to the slot in the axle bearing arrangement 20 and to the swing arm-side part of the coupling 19. The hub-side part of the coupling 43 is supported on the hub axle 35, and the hub axle 35 is surrounded by the hub-side part of the selector clutch, namely a ring with a stub 44, and the selector clutch, in turn, is surrounded by the hub-side part of the coupling 43. The hub-side part of the coupling 43 interacts via effective surfaces 43.1, 43.2 with the swing arm-side part of the coupling 19, which is supported on a bearing 22. The bearing 22 surrounds-a swing arm-side part of the selector clutch, namely a sleeve 45, and said sleeve is supported on a frame-side axle bearing 20 into which an axle securing means 48 can be inserted. The sleeve 45 can be retained axially by a retention pin 49 in the axle bearing arrangement 20.

When a shift device is actuated, the sleeve 45 is rotated, thereby transmitting a rotary motion to the ring with the stub 44 and hence to a shift mechanism situated in the hub. The system is preferably designed in such a way that removal of a wheel takes place in the hill-climbing gear, ensuring that the gear which is favorable for starting off is immediately engaged when the wheel is reinstalled. The sleeve 45 can be fixed axially on the axle bearing arrangement 20 by means of a retention pin, for example. To reduce the shifting forces, it is furthermore advantageous to support the sleeve 45 rotatably on a rolling contact bearing, especially a needle bearing.

FIG. 14 shows the swing arm-side part of the coupling 19 with the axle bearing arrangement 20, the output wheel 13 and a mechanism which fixes the position of the coupling part 19 and of the axle bearing arrangement 20 for removal of the wheel. The mechanism comprises a leaf spring 52, an operating element 50 and a positioning disk 51. The leaf spring 52 is attached at a first end 52.1 to an inner surface of the enclosure housing 7 of the traction element transmission and is preloaded in such a way that it is pressed inward toward the positioning disk 51. At two defined positions, the positioning disk 51 has a notch 53.1, 53.2 which interacts with the leaf spring 52. The leaf spring 52 can penetrate into the notch 53.1, 53.2 in such a way that it fixes the positioning disk 51. The positioning disk 51 itself is connected in a torsionally rigid manner to the swing arm-side part of the coupling 19.

In this arrangement, the leaf spring 52 can be pressed against the inside of the enclosure 7 of the traction element transmission by the operating element 50 if the intention is that the leaf spring 52 should not interact with the positioning disk 51 but should leave it free, as during operation of the traction element transmission for example. Here, the operating element 50 is embodied within the enclosure 7 of the traction element transmission as a semi-circle which acts against the force of the leaf spring 52. In this arrangement, the semi-circle rotates about a point that lies substantially on the straight line between the two ends of the circular arc. The leaf spring 52 can thus be pushed away from the positioning disk 51 by rotating the operating element 50 through the circular arc of the operating element 50. In another position of the operating element 50, in which the leaf spring 52 may at most be touched by the straight line between the two ends of the circular arc, the leaf spring 52 can engage in one of the notches 53.1, 53.2 of the positioning disk 51 and fix the positioning disk 51 and hence the swing arm-side part of the coupling 19.

In this arrangement, the notches 53.1, 53.2 in the positioning disk 51 are positioned in such a way that they fix the swing arm-side part of the coupling 19 in a position in which radial insertion of an axle of a wheel hub into the axle bearing arrangement 20 through this part of the coupling 19 is made possible. The position of the coupling part 19 does not change during this process, owing to the retention arrangement.

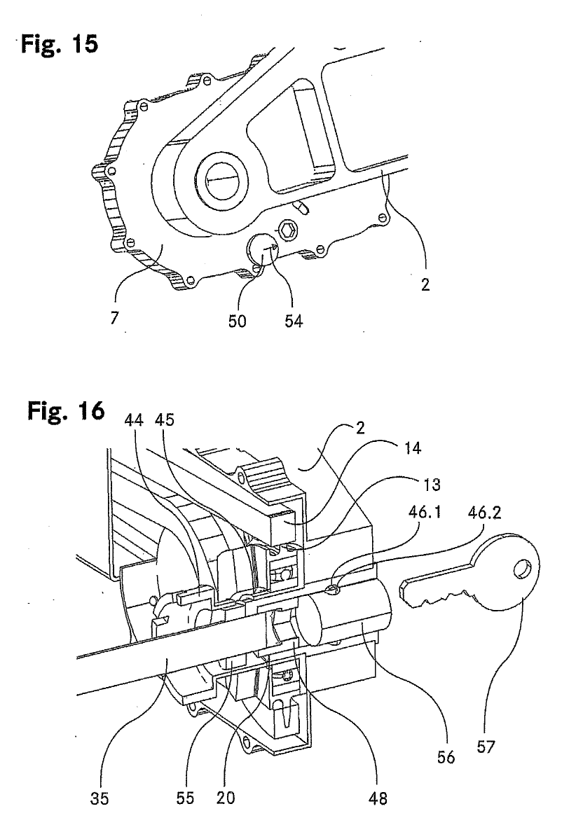

FIG. 15 shows the rear side of the enclosure 7 shown in FIG. 14, said enclosure being mounted on the swing arm 2. The operating element 50 has an indicator 54 that can be seen from the outside, in the form of an arrow for example, which indicates whether the system is in a condition ready for riding (in which case the arrow points forward) or in the condition for removal of the wheel (in which case the arrow points downward, upward or rearward).

FIG. 16 shows one possible configuration of an antitheft device for the hub. In the form illustrated here, this configuration is particularly suitable for hubs with a screwed axle. Mounted firmly on the axle 35 of a hub installed in the swing arm 2 is a nut 55 which forms an axial support surface with the axle bearing arrangement 20. Here, the axle is prevented from falling out by an axle securing means 48. A lock cylinder 56, which is inserted into the axle bearing arrangement 20 last locks the axle securing means 48 against unauthorized removal. The locking cams of the lock cylinder 56 can engage, for example, in a groove with a small notch effect in the axle bearing arrangement 20. Since the axle 35 has to be fastened in a torsionally rigid manner in the swing arm on the other side, namely the opposite side from the drive, because of the need to accept the torque acting on said axle, the screwed joint between the axle securing means 48 and the axle 35 on the drive side cannot be undone even by rotating the axle 35.

The axle securing means 48 on the drive side is furthermore connected positively to the dropout of the axle bearing arrangement 20. In contrast to conventional two-wheeled vehicles, where the rear wheel is held in the two-wheeled vehicle by frictional engagement alone, it is virtually impossible for the wheel to fall out unintentionally in this design, and this increases operational safety.

The figure shows a section through the screwed axle 35 and the locking device, the axle 35 being fastened in the axle bearing arrangement 20. The axle 35 with the ring having the stub 44, i.e. the hub-side part of the selector clutch, is accommodated by the axle bearing arrangement 20 and secured against falling out by an axle securing means 48 situated in the axle bearing arrangement 20. The axle securing means 48 is fixed in the axial direction by a lock cylinder 56, which is inserted into the axle bearing arrangement 20 from the outside, i.e. from the side opposite the axle 35. In its interior, the axle bearing arrangement 20 has a groove 46.1 into which locking cams 46.2 of the lock cylinder 56 can engage. The lock cylinder 56 can be locked with a key 57, for example, i.e. the locking cams 46.2 can be extended into and retracted from the groove 46.1 of the axle bearing arrangement 20 by operation with a key 57.

In addition to the form shown in the figures, it is also possible for the chain to be passed over guide wheels next to the rear-wheel swing arm or directly between the input wheel and the output wheel. In the case of an embodiment of the two-wheeled vehicle with a transmission situated in the frame, it is moreover necessary to pass the chain between the input wheel, which is situated at the transmission, and the output wheel in the region of the rear wheel. In this case too, the chain and its enclosure can be routed along a strut of the rear-wheel swing arm or taken over a direct route. The coupling means can be taken along a large number of different routes using a multiplicity of guide wheels. The only point to consider is that the efficiency of the traction element transmission decreases through additional guide wheels owing to frictional losses.

Also conceivable in general is a two-wheeled vehicle in which the front wheel is driven. Such a two-wheeled vehicle would be steered at its rear-wheel axle unless recourse were to be had to a complicated guide mechanism for the coupling means.

It is also possible for the eccentric for tensioning the coupling means to be provided at some wheel other than the input wheel. In principle, an embodiment of the output wheel or of a guide wheel which includes an eccentric will achieve the same end. Especially in the case of the output wheel, however, a shift in the position of the axis of the output wheel would also be associated with a shift in the position of the hub and hence of the driven wheel.

Apart from a torsion spring for preloading the wear-compensating mechanism, which torsion spring engages on the rotatable bearing arrangement of the lever, it is also possible to use some other spring element, such as a longitudinally acting spiral spring.

It is also possible for the positioning device illustrated in FIG. 14 for fixing the coupling to be embodied in some other way. To hold the coupling in a position in which fitting and removal of the axle into/from the axle bearing arrangement is possible, a spring element can enter into direct interaction with the output wheel. In addition, it is also possible for fixing of the coupling means to take place. There is no need for the use of a spring element here; manually fixed clamps can also be used, for example.

In summary, it may be stated that the invention provides a drive arrangement which allows safe and low-maintenance guidance of an endless coupling means and rapid, uncomplicated and efficient fitting and removal of a rear wheel of the two-wheeled vehicle.

1. A wheel hub for a two-wheeled vehicle, comprising
a) an axle,
b) a housing,
c) a driver,
d) a transmission with at least two different ratios, which couples the driver and the housing to one another,
e) an output wheel of a traction element transmission,
f) a releasable coupling, which couples the output wheel to the driver, and
g) an axle bearing,
the output wheel being attached to the two-wheeled vehicle in such a way that it remains on the two-wheeled vehicle when the coupling between the driver and the output wheel is released, and the axle being supported in the axle bearing for the purpose of fixing the wheel hub on the two-wheeled vehicle, a plane which is extended perpendicularly to the axle and extends through the coupling-side end of the axle being aligned substantially parallel to a center plane of the output wheel and to a plane extending through the transmission-side end of the drive-side axle bearing, and the plane which extends through the coupling-side end of the axle lying between the center plane of the output wheel and the plane which extends through the transmission-side end of the drive-side axle bearing, both in the fastened condition and during the release of the coupling.

2. The wheel hub as claimed in claim 1, wherein the coupling has effective surfaces which are aligned substantially parallel to the axle and are spaced apart from the axle, such that the coupling can be released by sliding the axle radially out of the axle bearing.

3. The wheel hub as claimed in claim 1, wherein the coupling has a mechanism which compensates for coaxial deviations and/or deviations in parallelism between the axle, the driver, the axle bearing and the output wheel, in particular a play or an elastic element between the effective surfaces of the coupling.

4. The wheel hub as claimed in claim 1, wherein the coupling comprises effective surfaces which are arranged symmetrically with respect to the axle in such a way that, during power transmission between the output wheel and the driver, forces acting in a radial direction on the axle cancel each other out, ensuring that it is substantially a resultant torque which is transmitted.

5. The wheel hub as claimed in claim 1, comprising a selector clutch for controlling the transmission, the selector clutch comprising a first part, which is supported rotatably on the axle, and the selector clutch comprising a second part, which is supported so as to be rotatable about the axle.

6. The wheel hub as claimed in claim 5, wherein the selector clutch can be released by a movement of the wheel hub which is exclusively radial with respect to the axle.

7. The wheel hub as claimed in claim 1, comprising a locking device for locking the wheel hub.

8. The wheel hub as claimed in claim 1, wherein the axle of the wheel hub is embodied in one piece.

9. The wheel hub as claimed in claim 1, wherein the output wheel is closed off from the environment and, in particular, is situated in a sealed casing.

10. The wheel hub as claimed in claim 1, wherein the axle bearing is embodied to receive the axle laterally, in particular through laterally arranged radial slots.

11. The wheel hub as claimed in claim 1, wherein the coupling transmits the rotary motion between the output wheel and the driver via two effective surfaces, each interacting in a paired configuration, a driver-side part of the coupling and a part of the coupling on the output-wheel side each having two effective surfaces.

12. The wheel hub as claimed in claim 11, wherein the effective surfaces of the coupling are aligned parallel to one another.

13. The wheel hub as claimed in claim 11, wherein the effective surfaces of the coupling are aligned obliquely in a paired configuration and parallel to one another in a paired configuration, thus facilitating the coupling process.

14. A two-wheeled vehicle comprising a wheel hub as claimed in claim 1.

15. A traction element transmission for a two-wheeled vehicle with a rear wheel, comprising
a) an input wheel,
b) an output wheel and
c) an endless coupling means between the input wheel and the output wheel, the input wheel and the output wheel interacting directly with the endless coupling means, further comprising
d) a first compensation mechanism acting on a guide wheel for the coupling means, said guide wheel being supported on a structural element of the two-wheeled vehicle, by means of which compensation mechanism the guide wheel, starting from a zero position, can be moved over a first radial path, and
e) a second compensation mechanism acting on a guide wheel for the coupling means, said guide wheel being supported on a structural element of the two-wheeled vehicle, by means of which compensation mechanism the guide wheel, starting from a zero position, can be moved over a second radial path,
the first path being longer than the second path and the second path being limited in such a way that a length of an envelope changes by not more than 0.5% of a length of the endless coupling means when the guide wheel moves over the second path.

16. The traction element transmission as claimed in claim 15, wherein the first path is longer than the second path by at least 10%, preferably by at least 40%, particularly preferably by at least 80%.

17. The traction element transmission as claimed in claim 15, wherein the same guide wheel can be moved over the first radial path and over the second radial path by means of the first compensation mechanism and of the second compensation mechanism.

18. The traction element transmission as claimed in claim 15, the rear wheel being supported on a swing arm which can move about an axis of rotation and is subject to a spring force, and the distance between the input wheel and the output wheel depending on the position of the mobile swing arm, wherein the distance between the axis of rotation of the mobile swing and a load-transmitting strand of the endless coupling means is less than the distance between the axis of rotation of the mobile swing arm and the axis of rotation of the input wheel.

19. The traction element transmission as claimed in claim 15, wherein the radial path of the guide wheel which can be moved by means of the second compensation mechanism is limited by fixed stops to less than 1%, preferably less than 0.1%, of the length of the endless coupling means during the operation of the traction element transmission.

20. The traction element transmission as claimed in claim 15, wherein the output wheel remains on the two-wheeled vehicle when the rear wheel is removed.

21. The traction element transmission as claimed in claim 15, wherein the first compensation mechanism and/or the second compensation mechanism comprises a preloaded elastic element for the purpose of supporting the corresponding guide wheel.

22. The traction element transmission as claimed in claim 21, wherein the elastic element is formed by an at least two-part axle, it being possible for a radially acting, preloaded spring element to be accommodated in a core axle, which spring element acts against a sleeve which forms a jacket around the core axle and is dimensioned in such a way that the sleeve can move radially around the core axle, in particular in a manner limited to one spatial direction.

23. The traction element transmission as claimed in claim 15, wherein the first compensation mechanism itself compensates for lengthening of the endless coupling means due to wear.

24. The traction element transmission as claimed in claim 15, the first compensation mechanism comprising the following:
a) a lever, on which a guide wheel is supported,
b) a pivot,
c) a torsion spring, and
d) a leaf spring,
the lever being supported on the pivot and being subjected to a torsional load in the direction of a first sense of rotation by the torsion spring, and the lever being provided with teeth which are arranged sawtooth-fashion in a grid shape and interact with the leaf spring.

25. The traction element transmission as claimed in claims 17 and 24, wherein the teeth are embodied sawtooth-fashion in such a way that, in interaction with the leaf spring, the lever can be rotated through a first angular range, in a first sense of rotation, about the pivot in order to move the guide wheel along the first radial path, and in that, in interaction with the leaf spring, the lever can be rotated through a second angular range, in a second sense of rotation, about the pivot in order to move the guide wheel along the second radial path, the first angular range being larger than the second angular range.

26. The traction element transmission as claimed in claim 25, wherein the first angular range is larger by at least 10%, preferably by at least 40%, particularly preferably by at least 80%, than the second angular range.

27. The traction element transmission as claimed in claim 25, the teeth each having recesses for the partial accommodation of the leaf spring, wherein the teeth interact with the leaf spring in such a way that the respective depth of the recesses limits the respective second angular range.

28. The traction element transmission as claimed in claim 15, having an indicator element which indicates a relative lengthening of the endless coupling means.

29. The traction element transmission as claimed in claim 15, wherein the load-bearing strand of the endless coupling means runs directly from the input wheel to the output wheel.

30. The traction element transmission as claimed in claim 15, having an enclosure which separates the traction element transmission, in particular the endless coupling means, from the environment.

31. The traction element transmission as claimed in claim 15, wherein the input wheel is supported in such a way by means of an eccentric that the position of the input wheel can be changed by rotation of the eccentric.

32. The traction element transmission as claimed in claim 18, wherein the endless coupling means runs at least partially within the swing arm.

33. A two-wheeled vehicle with a traction element transmission as claimed in claim 15.

34. A two-wheeled vehicle drive, comprising a traction element transmission as claimed in claim 15 and a wheel hub as claimed in claim 1, the traction element transmission and the wheel hub interacting in such a way that the output wheel of the traction element transmission is coupled to the driver of the wheel hub by means of the coupling of the wheel hub.

35. A two-wheeled vehicle comprising a two-wheeled vehicle drive as claimed in claim 34.
